(19) United States
(12) Patent Application Publication
(10) Pub. No.: US 2017/0154468 A1
(43) Pub. Date: Jun. 1, 2017

(54) METHOD AND ELECTRONIC APPARATUS FOR CONSTRUCTING VIRTUAL REALITY SCENE MODEL

(71) Applicants: Le Holdings (Beijing) Co., Ltd., Beijing (CN); LE SHI ZHI XIN ELECTRONIC TECHNOLOGY (TIANJIN) LIMITED, Beijing (CN)

(72) Inventor: Xiaofei Xu, Beijing (CN)

(21) Appl. No.: 15/246,962

(22) Filed: Aug. 25, 2016

Related U.S. Application Data
(63) Continuation of application No. PCT/CN2016/088508, filed on Jul. 5, 2016.

(30) Foreign Application Priority Data
Dec. 1, 2015 (CN) 201510872352.0

(51) Int. Cl. G06T 19/00

(52) U.S. Cl. CPC G06T 19/006

(57) ABSTRACT

A method and a device for constructing a virtual reality model are provided. The method for constructing a virtual reality scene includes the following steps. Generate a space coordinate system of the virtual reality scene. Generate multiple virtual object models of each of multiple virtual objects in the virtual reality scene in the space coordinate system. Integrate the multiple virtual object models to obtain an integrated object model. Map a texture map to the integrated object model to obtain the virtual reality scene model, the virtual reality scene model is programmed to be read and rendered by a display terminal for displaying the virtual reality scene.

### CROSS REFERENCE TO RELATED APPLICATIONS

This application is a continuation of International Application No. PCT/CN2016/088508, filed on Jul. 5, 2016, which is based upon and claims priority to Chinese Patent Application No. 201510872352.0, filed on Dec. 1, 2015, the entire contents of which are incorporated herein by reference.

### TECHNICAL FIELD

The embodiment of the present disclosure relates to a virtual reality technology, for example, particularly a method and an electronic apparatus for constructing a virtual reality scene model.

### BACKGROUND

Virtual reality is taking a high technology means with a computer technology as a core to generate a virtual environment with the integration of realistic visual, auditory, tactile, etc. User can interact with the object in the virtual reality through the display terminal.

For performing the virtual reality, it is necessary to digitally describe the virtual reality scene, and build a three dimensional model of the virtual reality scene, the display terminal can perform the three dimensional display of the virtual reality scene through reading the data of the model and rendering the model.

The inventor discovered, during the development of the disclosure, that: since the virtual reality scene is usually complicate, the virtual reality scene model being built by the virtual object models of each of the objects, as the display terminal reads the data of the model and rendering the model, it is necessary to read the virtual object model of each of the objects one by one and perform the rendering, for the complicate and redundant virtual reality scene model, the model rendering efficiency is affected.

### SUMMARY

An embodiment of the present disclosure provides a method and an electronic apparatus for constructing a virtual reality model so as to solve the technical issue of the low model rendering efficiency in the convention technology.

An embodiment of the present disclosure provides a method for constructing a virtual reality model, including:

generating a space coordinate system of the virtual reality scene;

generating multiple virtual object models of each of multiple virtual objects in the virtual reality scene in the space coordinate system;

integrating the multiple virtual object models to obtain an integrated object model; and

mapping a texture map to the integrated object model to obtain the virtual reality scene model, the virtual reality scene model programmed to be read and rendered by a display terminal for displaying the virtual reality scene.

An embodiment of the present application provides a non-volatile computer storage medium storing computer-executable instructions, and when the computer-executable instructions is executed by an electronic device, the electronic device execute the method for constructing a virtual reality scene model in any one of the embodiments of the present application.

An embodiment of the present application further provides an electronic apparatus, including: at least one processor; and a memory; wherein, the memory stores procedures which are executable by the at least one processor, when the instructions are executed by the at least one processor, the at least one processor execute the method for constructing a virtual reality scene model in any one of the embodiments of the present application.

The embodiments of the present disclosure provide a method and an electronic apparatus for constructing a virtual reality scene model, through combining each of the multiple virtual object models in the virtual reality scene being constructed, integrating and obtaining an integrated object model, directly mapping the texture map to the integrated object model, to obtain the virtual reality scene model, since the virtual reality model is one integrated object model, but not multiple independent virtual object models, when the display terminal read and render, there is no necessary to read the multiple virtual object models one by one and perform the rendering, separately, avoid the frequent operation, so that the model rendering efficiency is improved.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for constructing a virtual reality scene model in accordance with an embodiment of the present disclosure.

FIG. 2 is a flow chart of a method for constructing a virtual reality scene model in accordance with another embodiment of the present disclosure.

FIG. 3 is a structure schematic view of a device for constructing a virtual reality scene model in accordance with an embodiment of the present disclosure.

FIG. 4 is a structure schematic view of a device for constructing a virtual reality scene model in accordance with another embodiment of the present disclosure.

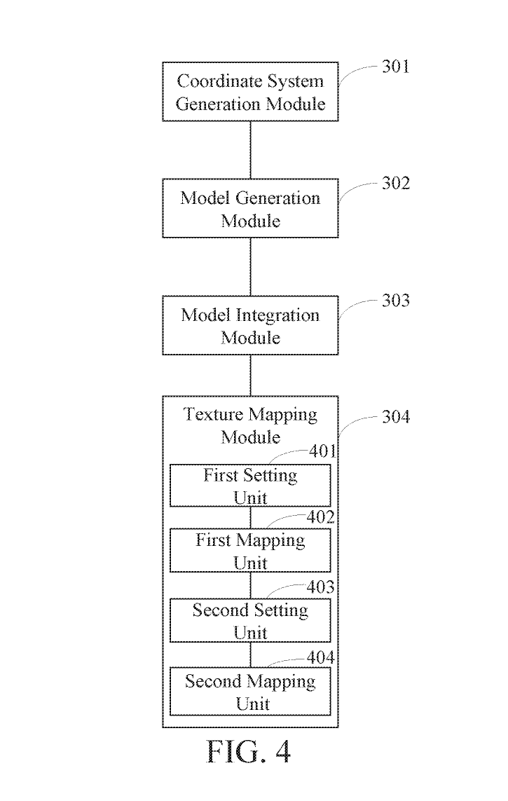

FIG. 5 is a hardware structure schematic view of an electronic apparatus for constructing a virtual reality scene model in accordance with an embodiment of the present disclosure.

### DETAILED DESCRIPTION

In order to make the purpose, the technical solution, and the advantages of the embodiments in the present disclosure more clearly, the following combines the drawings in the embodiments of the present disclosure to clearly and completely describe the technical solution of the embodiments of the present disclosure, obviously, the described embodiments are only a part of but not all the embodiments in the present disclosure. Based on the embodiments of the present disclosure, all other embodiments obtained by the people with the ordinary skill in the art without the creative work are within the protection scope of the present disclosure.

As shown in the background, for the complicate and redundant virtual reality scene model, the display terminal reads the virtual object models in the virtual reality scene model one by one, and perform the rendering in sequence, which will affect the model rendering efficiency, especially for the display terminals having the equipment performance of the hardware, such as the graphics card, etc., not comparable with the computer, for example, the mobile terminal such as cell phone, etc., which will significantly affect the model rendering efficiency, affect the display of the virtual reality scene.

The model rendering is the process of the display terminal performing the mapping and displaying according to the model data being read.

In order to improve the model rendering efficiency, the inventor conducts a series research and find out that the model rendering efficiency can be improved by optimizing the virtual reality scene model, and therefore, proposes the technical solution in the present disclosure; in the embodiment of the present disclosure, firstly, generate multiple virtual object models of each of multiple virtual objects in the virtual reality scene, and then integrate the multiple virtual object models to obtain an integrated object model, and directly map a texture map to the integrated object model to obtain the virtual reality model; since the virtual reality model is one integrated object model but not multiple independent virtual object models, when the display terminal read and render, there is no necessary to read the multiple virtual object models one by one and perform the rendering, separately, avoid the frequent operation, so that the model rendering efficiency is improved.

The followings combining with the drawings to give a detail description of the technical solution in the present disclosure.

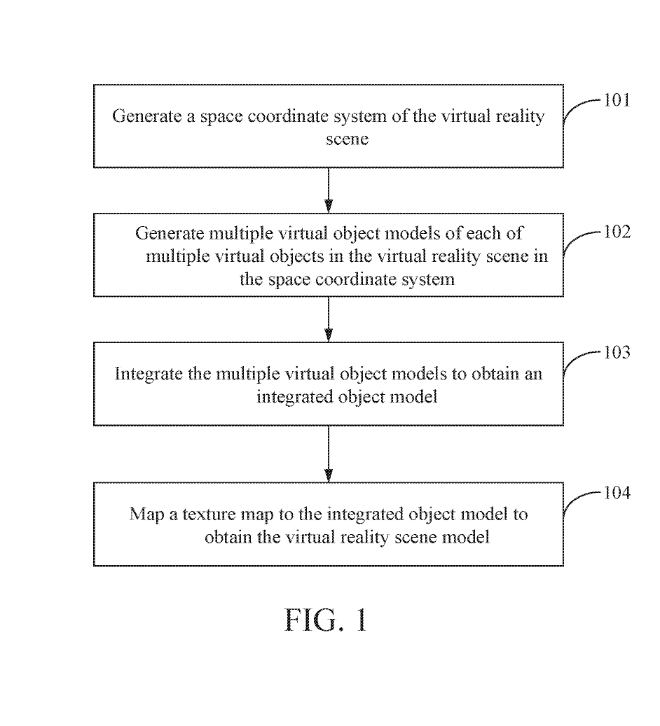

FIG. 1 is a flow chart of a method for constructing a virtual reality scene model in accordance with an embodiment of the present disclosure, and the method can include the following steps:

101: generate a space coordinate system of the virtual reality scene.

102: generate multiple virtual object models of each of multiple virtual objects in the virtual reality scene in the space coordinate system.

Wherein, generate the multiple virtual object models of each of the multiple virtual objects in the virtual reality scene in the space coordinate system can be generated based on geometric graphics. The geometric graphics, for example, can be vertices and triangles.

The models are all generated in the space coordinate system so that generate the space coordinate system, firstly.

Wherein, for the convenience of the display terminal to perform the model rendering, as another embodiment, the generation of a space coordinate system of the virtual reality scene can specifically be generating a space coordinate system of the virtual reality scene which is the same as a rendering coordinate while a model rendering is performed by the display terminal.

For example, when the display terminal perform the model rendering, the OpenGL ES (Open Graphics Library for Embedded Systems) is usually taken for performing the rendering of the models; therefore, the space coordinate system of the virtual reality scene being generated is the same as the coordinate system of the OpenGL ES and usually is a right-handed coordinate system.

The virtual reality scene, for example, can be a theater scene, and each of the virtual objects in the theater scene includes seats, film display panel, etc., and the virtual reality scene can be a beach scene, and each of the virtual objects in the beach scene includes water, yachts, beach umbrellas, sand, etc.

103: integrate the multiple virtual object models to obtain an integrated object model.

104: map a texture map to the integrated object model to obtain the virtual reality scene model, the virtual reality scene model programmed to be read and rendered by a display terminal for displaying the virtual reality scene

In the embodiment of the present disclosure, after generating each of the virtual object models in the virtual reality scene, it is not to map the texture map to each of the virtual object models, but merge and integrate each of the virtual object models to obtain the integrated object model, and then map the texture map to the integrated object model so as to obtain the virtual reality scene model; the virtual reality scene model is one integrated model but not being composed by the multiple virtual object models so that the display terminal only needs to read and render the integrated model one time when the display terminal reads and renders, which avoid the frequent operation so as to improve the model rendering efficiency.

Wherein, map the texture map to the integrated object model can generate the texture map of the integrated object model at the beginning, specifically, can integrate the texture map of each of the multiple virtual objects to obtain the texture map of the integrated object model. By setting the texture mapping coordinate of the integrated object model, the texture map can be mapped to the integrated model according to the texture mapping coordinate of the integrated object model.

The texture mapping coordinate defines location information of each of the vertices in the model so that the location of the texture map can be confirmed.

If the virtual display panel is included in the virtual reality scene such as the film display panel in the theater scene, the virtual display panel has to be used for displaying the real image so as to achieve the combination of virtuality and reality in the virtual reality.

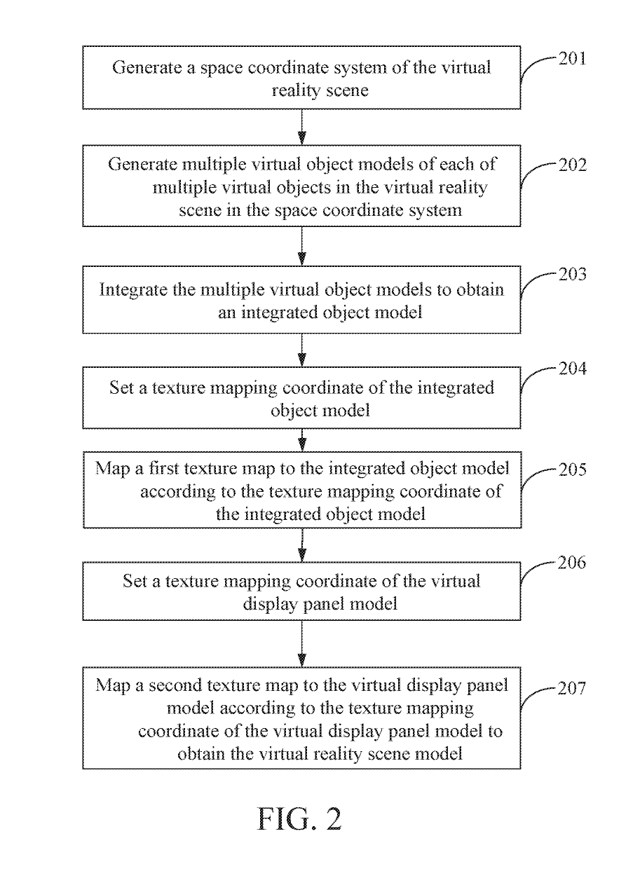

The display terminal performs the real image in the virtual display panel model of the virtual display panel, which use the texture mapping coordinate of the virtual display panel to project the real image into the virtual display panel model. In order to avoid the real image being projected into the whole integrated object model, as shown in FIG. 2, another embodiment of the method for constructing a virtual reality scene model in the present disclosure is provided, and in this embodiment, the method can include the following steps:

201: generate a space coordinate system of the virtual reality scene.

202: generate multiple virtual object models of each of multiple virtual objects in the virtual reality scene in the space coordinate system.

Wherein, the virtual reality scene includes the virtual display panel, the virtual object models of each of the virtual objects being generated include the virtual display panel model.

203: integrate the multiple virtual object models to obtain an integrated object model.

The operation in step 201 to step 203 is similar to the operation in step 101 to step 103 in the above embodiment so that the operation in step 201 to step 203 is not repeated hereafter.

204: set a texture mapping coordinate of the integrated object model.

205: map a first texture map to the integrated object model according to the texture mapping coordinate of the integrated object model.

206: set a texture mapping coordinate of the virtual display panel model.

207: map a second texture map to the virtual display panel model according to the texture mapping coordinate of the virtual display panel model to obtain the virtual reality scene model,

Wherein, the second texture map is programmed to determine a location of the virtual display panel for projecting a real image to the virtual display panel according to a texture coordinate of the second texture map when the display terminal displays the virtual reality scene model.

Through mapping the texture map of the virtual display panel alone in the integrated object model, the display terminal can rapidly determine the location of the virtual display panel in the integrated object model so that the real image can be projected into the virtual display panel.

The virtual display panel is mapped in the virtual reality scene when the display terminal reads and render the virtual reality scene model in the conventional technology, but the virtual display panel model is generated when the virtual reality scene model is generated in the embodiment of the present disclosure so that the displacement of the virtual display panel and the scene with each other can be avoid, which can improve the sense of immersion and increase the sense of reality of the virtual reality scene.

Wherein, in the several embodiments above, generate the virtual object models of each of the virtual objects in the virtual reality scene in the space coordinate system can include:

generating a camera location in the space coordinate system; the camera location representing a visual point location;

determining a geometric graphic number of each of the multiple virtual objects according to a distance between each of the multiple virtual objects and the camera location; and

generating the multiple virtual object models of each of the multiple virtual objects according to the geometric graphic number of each of the multiple virtual objects.

The camera location represents the visual point location, which is the eye location of the user when the user is watching the virtual reality scene; since the watching user is more than one, multiple camera location, such as eight camera locations, can be generated so that the display terminal can rapidly determine the visual point location of the user through generating the camera location.

When the number of the camera location is multiple, the distance between each of the virtual objects and the camera locations is specifically the distance between each of the virtual objects and the camera location which is the closest to the center point of the virtual reality scene.

Since the best watching point is the center point of the virtual reality scene, the camera location in the embodiment means the camera location which is the closest to the center point of the virtual reality scene.

The virtual object models of each of the virtual objects can be generated by the geometric graphics. The geometric graphic number for generating one virtual object model can be multiple, and the high and low of the geometric graphic number represents the precision of the model.

When the user is watching the virtual reality scene, the visual objects located far away from the visual point location usually have no special attention from the user so that the precision can be lower.

Therefore, basing on the distance between each of the virtual objects and the camera location, determining the geometric graphic number of each of the virtual objects being generated can be according to the distance between each of the virtual objects and the camera location; with the farther distance, can perform the generation by choosing the less geometric graphic number, and with the closer distance, can perform the generation by choosing the greater geometric graphic number.

As a possible implantation method, determine a geometric graphic number of each of the virtual objects according to a distance between each of the multiple virtual objects and the camera location can be:

determining multiple geometric graphic numbers of generating the virtual object model of each of the multiple virtual objects, wherein, a precision of the virtual object is proportional to the geometric graphic number;

determining the precision of each of the multiple virtual objects in sequence according to an order of each of the multiple virtual objects distanced away from to close to the camera location; wherein the precision of the virtual object distanced away from the camera location is lower than the precision of the virtual object distanced close to the camera location; and

selecting the geometric graphic number corresponding to the precision as the geometric graphic number of each of the multiple virtual objects for each of the multiple virtual objects.

For example, the virtual object with the distance to the camera location greater than a first predetermined distance can choose the small geometric graphic number to generate the corresponding virtual object model; the virtual object with the distance to the camera location smaller than a second predetermined distance can choose the large geometric graphic number to generate the corresponding virtual object model, and the first predetermined distance is greater than or equal to the second predetermined distance.

Specifically, the small geometric graphic number can be chosen to generate the virtual object model of the virtual object with a distance to the camera location greater than the first predetermined distance; the large geometric graphic number can be chosen to generate the virtual object model of the virtual object with a distance to the camera location smaller than the second predetermined distance.

Dividing by the precision, the precision of each of the virtual object models is different; the virtual object distanced away from the camera location can choose the smaller geometric graphic number to perform the generation so as to reduce the resource occupied by the model for further improving the rendering efficiency.

For example, to ensure the rendering speed can be more than thirty frames, a range of the number of the vertices is 1 to 100,000, and the number of the triangles is 1 to 100,000. During the organization process of the model, try to ensure the vertices number of the model is less than twice of the triangle number.

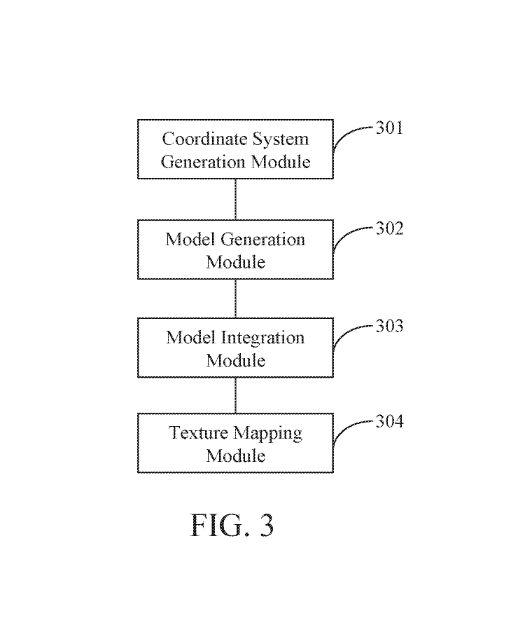

FIG. 3 is a structure schematic view of a device for constructing a virtual reality scene model in accordance with an embodiment of the present disclosure, and the device can include:

a coordinate system generation module 301 programmed to generate a space coordinate system of the virtual reality scene as an other embodiment, the coordinate system generation module is specifically programmed to:

generate the space coordinate system of the virtual reality scene being the same as a rendering coordinate while a model rendering is performed by the display terminal.

A model generation module 302 programmed to generate multiple virtual object models of each of multiple virtual objects in the virtual reality scene in the space coordinate system;

a model integration module 303 programmed to integrate the multiple virtual object models to obtain an integrated object model;

a texture mapping module 304 programmed to map a texture map to the integrated object model to obtain the virtual reality scene model, and the virtual reality scene model programmed to be read and rendered by a display terminal for displaying the virtual reality scene.

In the embodiment of the present disclosure, after generating each of the multiple virtual object models in the virtual reality scene, it is not mapping the texture map to each of the virtual object models but integrating the multiple virtual object models to obtain an integrated object model, and map a texture map to the integrated object model to obtain the virtual reality model; since the virtual reality model is one integrated object model but not multiple independent virtual object models, when the display terminal read and render, only need to read and render the integrated model one time, avoid the frequent operation, so that the model rendering efficiency is improved.

Wherein, the texture mapping module maps the texture map to the integrated object model can generate the texture map of the integrated object model at the beginning, specifically, can integrate the textures of each of the virtual objects to obtain the texture map of the integrated object model. Through setting the texture mapping coordinate of the integrated object model, according to the texture mapping coordinate of the integrated object model, the texture can be mapped to the integrated model.

The texture mapping coordinate defines the location information of each vertices in the model so as to determine the location of the texture map.

If the virtual display panel is included in the virtual reality scene, such as the film display panel in the theater scene, the virtual display panel has to be used for displaying real image in the virtual reality so as to achieve the combination of virtuality and reality in the virtual reality. The display terminal performs the real image in the virtual display panel model of the virtual display panel, which use the texture mapping coordinate of the virtual display panel module to project the real image into the virtual display panel model. In order to avoid the real image being projected into the whole integrated object model, as shown in FIG. 2, as another embodiment,

the texture mapping module 304 can includes:

a first setting unit 401 programmed to set a texture mapping coordinate of the integrated object model;

a first mapping unit 402 programmed to map a first texture map to the integrated object model according to the texture mapping coordinate of the integrated object model;

a second setting unit 403 programmed to set a texture mapping coordinate of the virtual display panel model; and

a second mapping unit 404 programmed to map a second texture map to the virtual display panel model according to the texture mapping coordinate of the virtual display panel model to obtain the virtual reality scene model, the second texture map programmed to determine a location of the virtual display panel for projecting a real image to the virtual display panel according to a texture coordinate of the second texture map when the display terminal displays the virtual reality scene model.

Through mapping the texture map of the virtual display panel alone in the integrated object model, the display terminal can rapidly determine the location of the virtual display panel in the integrated object model so that the real image can be projected into the virtual display panel.

The virtual display panel is mapped in the virtual reality scene when the display terminal reads and render the virtual reality scene model in the conventional technology, but the virtual display panel model is generated when the virtual reality scene model is generated in the embodiment of the present disclosure so that the displacement of the virtual display panel and the scene with each other can be avoid, which can improve the sense of immersion and increase the sense of reality of the virtual reality scene.

Wherein, as another embodiment, the model generation module can include:

a location determination unit programmed to generate a camera location in the space coordinate system; the camera location representing a visual point location;

a number determination unit programmed to determine a geometric graphic number of each of the multiple virtual objects according to a distance between each of the multiple virtual objects and the camera location; and

a model generation unit programmed to generate the multiple virtual object models of each of the multiple virtual objects according to the geometric graphic number of each of the multiple virtual objects.

The camera location represents the visual point location, which is the eye location of the user when the user is watching the virtual reality scene; since the watching user is more than one, multiple camera location, such as eight camera locations, can be generated so that the display terminal can rapidly determine the visual point location of the user through generating the camera location.

The virtual object models of each of the virtual objects can be generated by the geometric graphics. The geometric graphic number for generating one virtual object model can be multiple, and the high and low of the geometric graphic number represents the precision of the model.

When the user is watching the virtual reality scene, the visual objects located far away from the visual point location usually have no special attention from the user so that the precision can be lower.

Therefore, basing on the distance between each of the virtual objects and the camera location, determining the geometric graphic number of each of the virtual objects being generated can be according to the distance between each of the virtual objects and the camera location; with the farther distance, can perform the generation by choosing the less geometric graphic number, and with the closer distance, can perform the generation by choosing the greater geometric graphic number.

As a possible implantation method, the number determination unit can be specifically programmed to:

determine multiple geometric graphic numbers of generating the virtual obj ect model of each of the multiple virtual objects, wherein, a precision of the virtual object is proportional to the geometric graphic number;

determine the precision of each of the multiple virtual objects in sequence according to an order of each of the multiple virtual objects distanced away from to close to the camera location; wherein the precision of the virtual object distanced away from the camera location is lower than the precision of the virtual object distanced close to the camera location; and

select the geometric graphic number corresponding to the precision as the geometric graphic number of each of the multiple virtual objects for each of the multiple virtual objects.

For example, the virtual object with the distance to the camera location greater than a first predetermined distance can choose the small geometric graphic number to generate the corresponding virtual object model; the virtual object with the distance to the camera location smaller than a second predetermined distance can choose the large geometric graphic number to generate the corresponding virtual object model, and the first predetermined distance is greater than or equal to the second predetermined distance.

According to the embodiment of the present disclosure, through merge and integrate each of the virtual object models to obtain the integrated object model so that the display terminal only needs to read and render the integrated model one time when the display terminal reads and renders, which avoid the frequent operation so as to improve the model rendering efficiency.

The apparatus described above embodiments are merely illustrative, wherein the unit as a separate member described may or may not be physically separate, as part of the display unit may or may not be physical units, i.e., it may be located in one place, or may be distributed to multiple network elements. You can select some or all of the modules to achieve the purpose of the present example of embodiment according to the actual program needs. Those of ordinary skill in the case without paying any creative work that can be understood and implemented.

An embodiment of the present application further provides a non-volatile computer storage medium storing computer-executable instructions, and the computer-executable instructions can carry out the method for constructing a virtual reality scene model in any one of the embodiments of the present application.

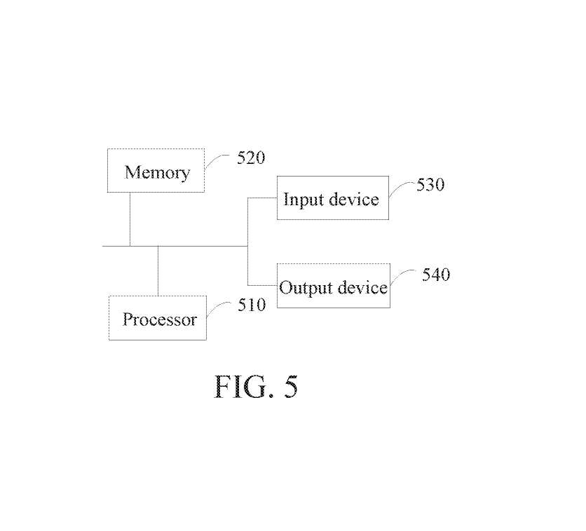

FIG. 5 is a hardware structure schematic view of an electronic apparatus for constructing a virtual reality scene model in accordance with an embodiment of the present disclosure, and the apparatus includes: one or multiple processor(s) 510 and a memory 520. The number of the processor 510 is one in FIG. 5 as an example.

The apparatus for executing the method for constructing a virtual reality scene model can further include: an input device 530 and an output device 540.

The processor 510, the memory 520, the input device 530, and the output device 540 can be connected to each other via a bus or other members for electrical connection. In FIG. 5, they are connected to each other via the bus in this embodiment.

The memory 520 is one kind of non-volatile computer-readable storage mediums applicable to store non-volatile software programs, non-volatile computer-executable programs and modules; for example, the program instructions and the function modules corresponding to the method for construction a virtual reality scene model in the embodiments. The processor 510 executes function disclosures and data processing of the server by running the non-volatile software programs, non-volatile computer-executable programs and modules stored in the memory 520, and thereby the method for constructing a virtual reality scene model in the aforementioned embodiments are achievable.

The memory 520 can include a program storage area and a data storage area, wherein the program storage area can store an operating system and at least one disclosure program required by a function; the data storage area can store the data created according to the method for constructing a virtual reality scene model. Furthermore, the memory 520 can include a high speed random-access memory, and further include a non-volatile solid state memory such as at least one disk storage member, at least one flash memory member and other non-volatile solid state storage member. In some embodiments, the memory 520 can have a remote connection with the processor 510, and such remote memory can be connected to the device for constructing a virtual reality scene model by a network. The aforementioned network includes, but not limited to, internet, intranet, local area network, mobile communication network and combination thereof.

The input device 530 can receive digital or character information, and generate a button signal input corresponding to the user setting and the function control of the method for constructing a virtual reality scene model. The output device 540 can include a displaying unit such as screen.

The one or more modules are stored in the memory 520. When the one or more modules are executed by one or more processor 510, the method for constructing a virtual reality scene model disclosed in any one of the embodiments is performed.

The aforementioned product can execute the method provided in the embodiment of the present disclosure, having the function modules and beneficial effects corresponding to execute the method. The technical details which are not clearly described in this embodiment can be referred to the method provided in the embodiments of the present disclosure.

The electronic apparatus in the embodiments of the present disclosure is presence in many forms, and the electronic apparatus includes, but not limited to:

(1) Mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.

(2) Ultra-mobile personal computer apparatus: this type of apparatus belongs to the category of personal computers, there are calculating and processing capabilities, generally includes mobile Internet characteristic. This type of terminals include: PDA, MID and UMPC equipment, etc., such as iPad.

(3) Portable entertainment apparatus: this type of apparatus can display and play multimedia contents. This type of apparatuses: audio, video player (e.g. iPod), handheld game console, e-books, as well as smart toys and portable vehicle-mounted navigation apparatus.

(4) Server: an apparatus provide calculating service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.

(5) Other electronic apparatus having a data exchange function.

The above-described apparatus embodiments are merely illustrative, wherein units described as separate parts may or may not be physically separated, part as display unit may or may not be a physical unit, which may be located in one place, or can be distributed to multiple network elements. You can select some or all of the modules to achieve the purpose of the present embodiment according to the actual requirements.

Through the above description of the implementation manners, a person skilled in the art can clearly understand that, the aspects of the present disclosure may be achieved in a manner of combining software and a necessary common hardware platform, and certainly may also be achieved by hardware. Based on such understanding, the technical solutions of the aspects of the present disclosure can be reflected in a form of a software product. The computer software product is stored in a computer readable storage medium such as ROM/RAM, hard disk, CD, etc., includes several instructions to make a computer device (which may be a personal computer, a server, a network device, or the like) execute the method described in the embodiments or a part of the embodiments.

Finally, it should be noted that: the above embodiments are merely to illustrate the technical solutions of the present application, but not intended to limit; although the present application has been described in detail refer to the above embodiments, it should be clear to those skilled in the art that the technical solutions in the above embodiments can be amended, or a part of the technical features can be equivalently replaced; these amendments and replacements will not make the spirit of the corresponding technical solution departing from the spirit and the scope of the present disclosure.

What is claimed is:

1. A method for constructing a virtual reality scene model, applied at an electronic apparatus, comprising:
generating a space coordinate system of the virtual reality scene;
generating multiple virtual object models of each of multiple virtual objects in the virtual reality scene in the space coordinate system;
integrating the multiple virtual object models to obtain an integrated object model; and
mapping a texture map to the integrated object model to obtain the virtual reality scene model, the virtual reality scene model programmed to be read and rendered by a display terminal for displaying the virtual reality scene.

2. The method according to claim 1, wherein the virtual reality scene comprises a virtual display panel, the multiple virtual object models comprise a virtual display panel model of the virtual display panel;
the step of mapping the texture to the integrated object model to obtain the virtual reality scene model comprise:
setting a texture mapping coordinate of the integrated object model;
mapping a first texture map to the integrated object model according to the texture mapping coordinate of the integrated object model;
setting a texture mapping coordinate of the virtual display panel model; and
mapping a second texture map to the virtual display panel model according to the texture mapping coordinate of the virtual display panel model to obtain the virtual reality scene model, the second texture map programmed to determine a location of the virtual display panel for projecting a real image to the virtual display panel according to a texture coordinate of the second texture map when the display terminal displays the virtual reality scene model.

3. The method according to claim 1, wherein the step of generating the space coordinate system of the virtual reality scene comprise:
generating the space coordinate system of the virtual reality scene being the same as a rendering coordinate while a model rendering is performed by the display terminal.

4. The method according to claim 1, wherein the step of generating the multiple virtual object models of each of the multiple virtual objects in the virtual reality scene in the space coordinate system comprises:
generating a camera location in the space coordinate system; the camera location representing a visual point location;
determining a geometric graphic number of each of the multiple virtual objects according to a distance between each of the multiple virtual objects and the camera location; and
generating the multiple virtual object models of each of the multiple virtual objects according to the geometric graphic number of each of the multiple virtual objects.

5. The method according to claim 4, wherein the step of determining the geometric graphic number of each of the multiple virtual objects according to the distance between each of the multiple virtual objects and the camera location comprises:
determining multiple geometric graphic numbers of generating the virtual object model of each of the multiple virtual objects, wherein, a precision of the virtual object is proportional to the geometric graphic number;
determining the precision of each of the multiple virtual objects in sequence according to an order of each of the multiple virtual objects distanced away from to close to the camera location; wherein the precision of the virtual object distanced away from the camera location is lower than the precision of the virtual object distanced close to the camera location; and
selecting the geometric graphic number corresponding to the precision as the geometric graphic number of each of the multiple virtual objects for each of the multiple virtual objects.

6. A non-volatile computer storage medium, storing computer-executable instructions that, when executed by an electronic device, cause the electronic device to:
generate a space coordinate system of a virtual reality scene;
generate multiple virtual object models of each of multiple virtual objects in the virtual reality scene in the space coordinate system;
integrate the multiple virtual object models to obtain an integrated object model; and
map a texture map to the integrated object model to obtain a virtual reality scene model, the virtual reality scene model programmed to be read and rendered by a display terminal for displaying the virtual reality scene.

7. An electronic apparatus, comprising:
at least one processor; and
a memory communicatively connected to the at least one processor; wherein,
the memory stores instructions which can be executed by the at least one processor, when the instructions are executed by the at least one processor, cause the at least one processor to:
generate a space coordinate system of a virtual reality scene;
generate multiple virtual object models of each of multiple virtual objects in the virtual reality scene in the space coordinate system;
integrate the multiple virtual object models to obtain an integrated object model; and
map a texture map to the integrated object model to obtain a virtual reality scene model, the virtual reality scene model programmed to be read and rendered by a display terminal for displaying the virtual reality scene.

8. The non-volatile computer storage medium according to claim 6, wherein the virtual reality scene comprises a virtual display panel, the multiple virtual object models comprise a virtual display panel model of the virtual display panel;
the step of mapping the texture to the integrated object model to obtain the virtual reality scene model comprises:
setting a texture mapping coordinate of the integrated object model;
mapping a first texture map to the integrated object model according to the texture mapping coordinate of the integrated object model;
setting a texture mapping coordinate of the virtual display panel model; and
mapping a second texture map to the virtual display panel model according to the texture mapping coordinate of the virtual display panel model to obtain the virtual reality scene model, the second texture map programmed to determine a location of the virtual display panel for projecting a real image to the virtual display panel according to a texture coordinate of the second texture map when the display terminal displays the virtual reality scene model.

9. The non-volatile computer storage medium according to claim 6, wherein the step of generating the space coordinate system of the virtual reality scene comprises:
generating the space coordinate system of the virtual reality scene being the same as a rendering coordinate while a model rendering is performed by the display terminal.

10. The non-volatile computer storage medium according to claim 6, wherein the step of generating the multiple virtual object models of each of the multiple virtual objects in the virtual reality scene in the space coordinate system comprises:
generating a camera location in the space coordinate system; the camera location representing a visual point location;
determining a geometric graphic number of each of the multiple virtual objects according to a distance between each of the multiple virtual objects and the camera location; and
generating the multiple virtual object models of each of the multiple virtual objects according to the geometric graphic number of each of the multiple virtual objects.

11. The non-volatile computer storage medium according to claim 10, wherein the step of determining the geometric graphic number of each of the multiple virtual objects according to the distance between each of the multiple virtual objects and the camera location comprises:
determining multiple geometric graphic numbers of generating the virtual object model of each of the multiple virtual objects, wherein, a precision of the virtual object is proportional to the geometric graphic number;
determining the precision of each of the multiple virtual objects in sequence according to an order of each of the multiple virtual objects distanced away from to close to the camera location; wherein the precision of the virtual object distanced away from the camera location is lower than the precision of the virtual object distanced close to the camera location; and
selecting the geometric graphic number corresponding to the precision as the geometric graphic number of each of the multiple virtual objects for each of the multiple virtual objects.

12. The electronic apparatus according to claim 7, wherein the virtual reality scene comprises a virtual display panel, the multiple virtual object models comprise a virtual display panel model of the virtual display panel;
the step of mapping the texture to the integrated object model to obtain the virtual reality scene model comprises:
setting a texture mapping coordinate of the integrated object model;
mapping a first texture map to the integrated object model according to the texture mapping coordinate of the integrated object model;
setting a texture mapping coordinate of the virtual display panel model; and
mapping a second texture map to the virtual display panel model according to the texture mapping coordinate of the virtual display panel model to obtain the virtual reality scene model, the second texture map programmed to determine a location of the virtual display panel for projecting a real image to the virtual display panel according to a texture coordinate of the second texture map when the display terminal displays the virtual reality scene model.

13. The electronic apparatus according to claim 7, wherein the step of generating the space coordinate system of the virtual reality scene comprises:
generating the space coordinate system of the virtual reality scene being the same as a rendering coordinate while a model rendering is performed by the display terminal

14. The electronic apparatus according to claim 7, wherein the step of generating the multiple virtual object models of each of the multiple virtual objects in the virtual reality scene in the space coordinate system comprises:
generating a camera location in the space coordinate system; the camera location representing a visual point location;
determining a geometric graphic number of each of the multiple virtual objects according to a distance between each of the multiple virtual objects and the camera location; and
generating the multiple virtual object models of each of the multiple virtual objects according to the geometric graphic number of each of the multiple virtual objects.

15. The electronic apparatus according to claim 14, wherein the step of determining the geometric graphic number of each of the multiple virtual objects according to the distance between each of the multiple virtual objects and the camera location comprises:
determining multiple geometric graphic numbers of generating the virtual object model of each of the multiple virtual objects, wherein, a precision of the virtual object is proportional to the geometric graphic number;
determining the precision of each of the multiple virtual objects in sequence according to an order of each of the multiple virtual objects distanced away from to close to the camera location; wherein the precision of the virtual object distanced away from the camera location is lower than the precision of the virtual object distanced close to the camera location; and
selecting the geometric graphic number corresponding to the precision as the geometric graphic number of each of the multiple virtual objects for each of the multiple virtual objects.
